(19) United States
(12) Patent Application Publication
(10) Pub. No.: US 2026/0235242 A1
(43) Pub. Date: Aug. 13, 2026

(54) QUICK DISCONNECTOR

(71) Applicant: HSIU-YUN LIU, Changhua City (TW)

(72) Inventor: HSIU-YUN LIU, Changhua City (TW)

(21) Appl. No.: 19/423,265

(22) Filed: Dec. 17, 2025

(30) Foreign Application Priority Data
Feb. 7, 2025 (TW) 114104543

(51) Int. Cl. F16L 37/256; F16L 37/34

(52) U.S. Cl. CPC F16L 37/256; F16L 37/34

(57) ABSTRACT

A quick disconnector includes a first connector unit and a second connector unit. The first connector unit has a first connector body defining a first flow passage, a first abut member fixedly disposed in the first flow passage, a first blocking member axially movably positioned in the first flow passage, and a first elastic member disposed between the first blocking member and the first abut member. The second connector unit has a second connector body defining a second flow passage, a second abut member fixedly disposed in the second flow passage, an annular thrust member axially movably positioned between the second abut member and a second blocking member, and a second elastic member disposed between the annular thrust member and a second pipe connecting port.

### FIELD OF THE INVENTION

The present invention relates to a connector device, and more particularly to a quick disconnector.

### BACKGROUND OF THE INVENTION

Quick disconnectors are extensively employed in industrial equipment and consumer products for connecting pipelines. They are particularly advantageous in applications requiring frequent coupling and decoupling of pipelines, thereby enhancing the operational efficiency of connection and disconnection.

Conventional quick disconnectors are typically equipped with an elastic member, such as a coil spring, a spring plate, or a rubber pad, which continuously applies a clamping force during the coupled state of two pipelines. This clamping force secures the pipelines against unintentional separation and maintains fluid communication therebetween.

However, with prolonged use, the elastic member is susceptible to fatigue caused by repeated compression and rebound cycles. Such fatigue reduces the clamping force of the quick disconnector, undermines the stability of the coupling, and compromises the reliability of fluid communication between the pipelines. Consequently, the pipelines may inadvertently separate during operation.

### SUMMARY OF THE INVENTION

It is therefore an object of the present invention to provide a quick disconnector that enables a user to efficiently couple and decouple connector units, while preventing the two joined connector units from disengaging as a result of elastic fatigue of internal elastic members during use. The quick disconnector thereby achieves enhanced coupling stability.

The quick disconnector comprises a first connector unit and a second connector unit.

The first connector unit comprises a first connector body, a first abut member, a first elastic member, and a first blocking member. The first connector body is a hollow tubular body defining a first flow passage extending axially therethrough, and is provided with a first engagement port and a first pipe connecting port disposed at opposite axial ends thereof. The first abut member is fixedly disposed within the first flow passage adjacent to the first pipe connecting port. The first blocking member is axially movably disposed within the first flow passage adjacent to the first engagement port. The first elastic member is disposed on the first abut member and is positioned between the first blocking member and the first abut member.

The second connector unit comprises a second connector body, a second abut member, a second elastic member, a second blocking member, and an annular thrust member. The second connector body is a hollow tubular body defining a second flow passage extending axially therethrough, and is provided with a second engagement port and a second pipe connecting port disposed at opposite axial ends thereof. The second abut member is fixedly disposed within the second flow passage at a position spaced apart from the second engagement port. The second blocking member is connected to the second abut member on a side facing the second engagement port. The annular thrust member is axially movably disposed annularly around the second abut member and the second blocking member. The second elastic member is annularly disposed around the second abut member and is positioned between the annular thrust member and the second pipe connecting port.

In one embodiment, a first outer diameter of the first connector body is smaller than a second outer diameter of the second connector body.

The technical effect of the present invention is that, when the first connector body and the second connector body are coupled, the first elastic member continuously exerts an elastic restoring force on the first blocking member, thereby causing the first blocking member and the second blocking member to abut against one another. Simultaneously, the second elastic member continuously exerts an elastic restoring force on the annular thrust member, thereby causing the annular thrust member and the first engagement port to abut against one another. Through the cooperative structural design of the first elastic member and the second elastic member, reliable communication between the first flow passage and the second flow passage is ensured, thereby preventing loss of fluid communication due to elastic fatigue of either elastic member.

### BRIEF DESCRIPTION OF THE DRAWINGS

FIG. 1 is a schematic view illustrating an embodiment of the quick disconnector according to the present invention;

FIGS. 2A and 2B are exploded schematic views respectively illustrating components of a first connector unit and a second connector unit of the embodiment;

FIG. 3 is a sectional view taken along line III–III of FIG. 1, illustrating the internal structure of the embodiment;

FIG. 4 is a schematic view illustrating the structural configuration of the embodiment in a coupled state; and

FIG. 5 is a sectional view taken along line V–V of FIG. 4, illustrating the internal structure of the embodiment in the coupled state.

### DETAILED DESCRIPTION OF THE PREFERRED EMBODIMENTS

The technical content and advantageous effects of the present invention will be clearly described with reference to the accompanying drawings and the following embodiments. It should be noted that the drawings are provided solely to illustrate the relative positional relationships between the components of the invention and are not intended to reflect the actual dimensions of the components.

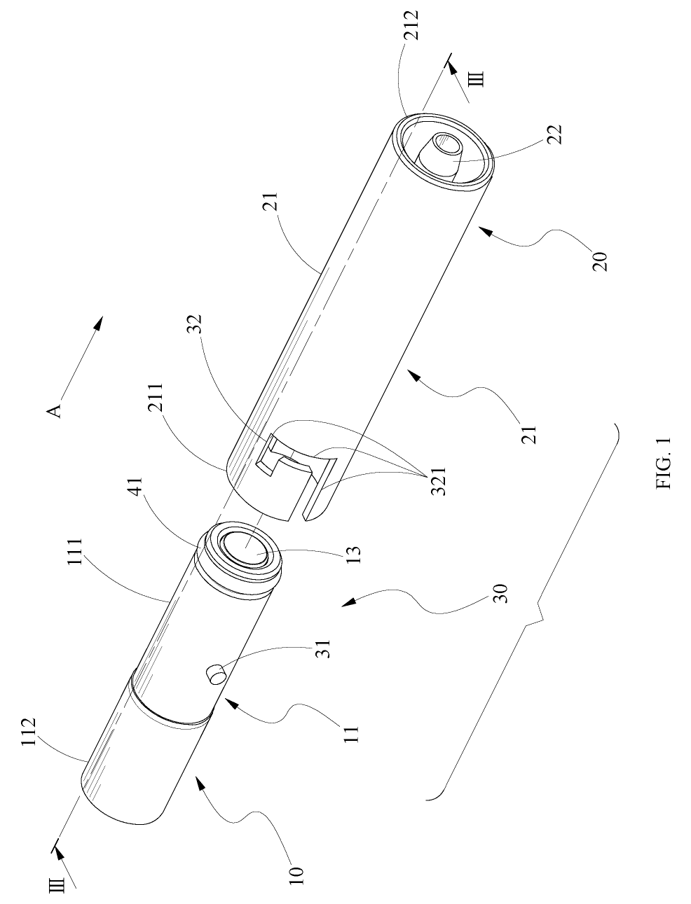

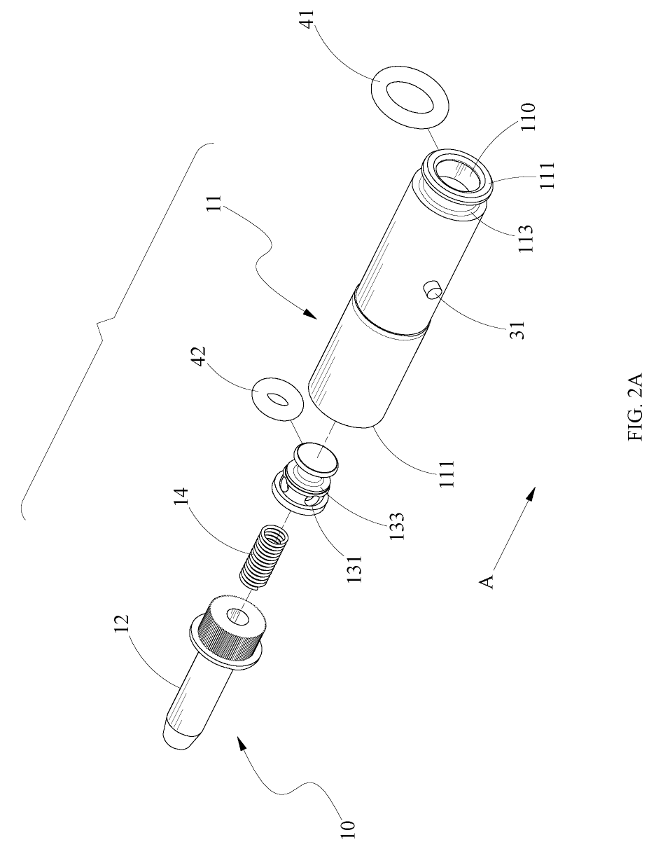

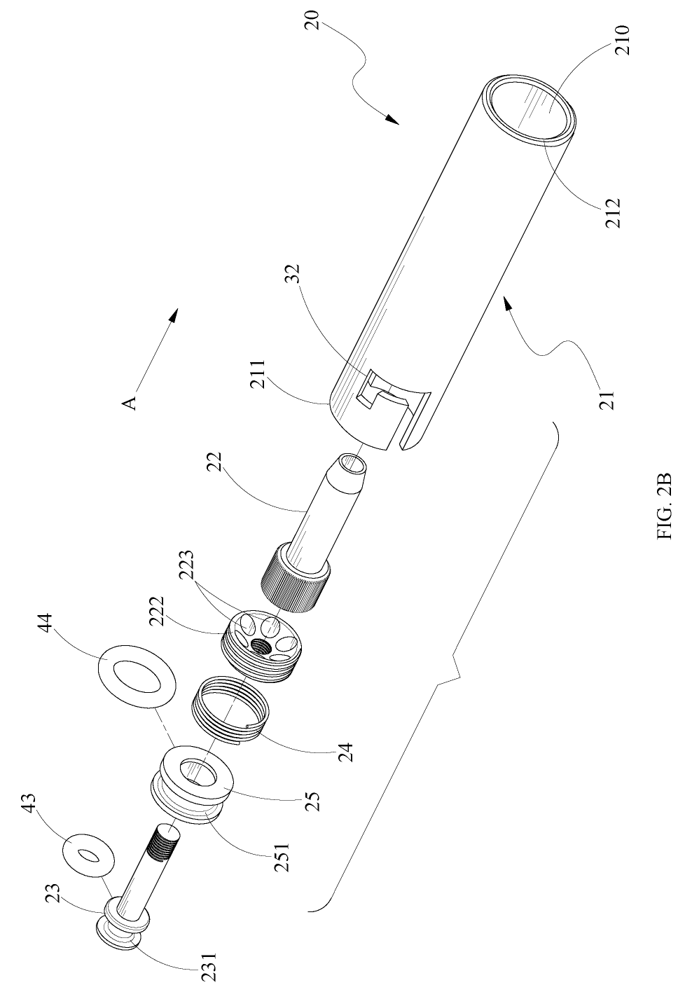

Referring to FIGS. 1, 2A, and 3, an embodiment of the quick disconnector according to the present invention is illustrated. The quick disconnector comprises a first connector unit (10), a second connector unit (20), and a latching unit (30).

The first connector unit (10) comprises a first connector body (11), a first abut member (12), a first blocking member (13), and a first elastic member (14).

The first connector body (11) is a hollow tubular body defining a first flow passage (110) that axially extends through the first connector body (11). The first connector body (11) has a first engagement port (111) and a first pipe connecting port (112) disposed at opposite axial ends thereof.

In the present embodiment, the first flow passage (110) includes a reduced-diameter section adjacent to the first engagement port (111), the inner diameter of which is smaller than the inner diameter of the remaining portion of the first flow passage (110). An inner sidewall of the first connector body (11) forms an inwardly projecting platform portion (114). The platform portion (114) is spaced from the first pipe connecting port (112) along an axial direction A and is located on a side of the reduced-diameter section opposite to the first engagement port (111). In addition, the first connector body (11) further comprises an outer annular groove (113) recessed into an outer peripheral wall of the first connector body (11) adjacent to the first engagement port (111). The outer annular groove (113) accommodates a sealing ring (41).

The first abut member (12) is fixedly disposed within the first flow passage (110) adjacent to the first pipe connecting port (112). The first abut member (12) defines a first sub-flow passage (121) in fluid communication with the first flow passage (110).

In this embodiment, a side of the first abut member (12) remote from the first pipe connecting port (112) forms a first abutting portion (122). The first abutting portion (122) abuts the platform portion (114), thereby securing the first abut member (12) within the first flow passage (110).

The first blocking member (13) is axially movably disposed within the first flow passage (110).

When the first connector unit (10) is not engaged with the second connector unit (20), the first blocking member (13) is positioned adjacent to the first engagement port (111), thereby closing the first flow passage (110) and preventing external communication through the first engagement port (111).

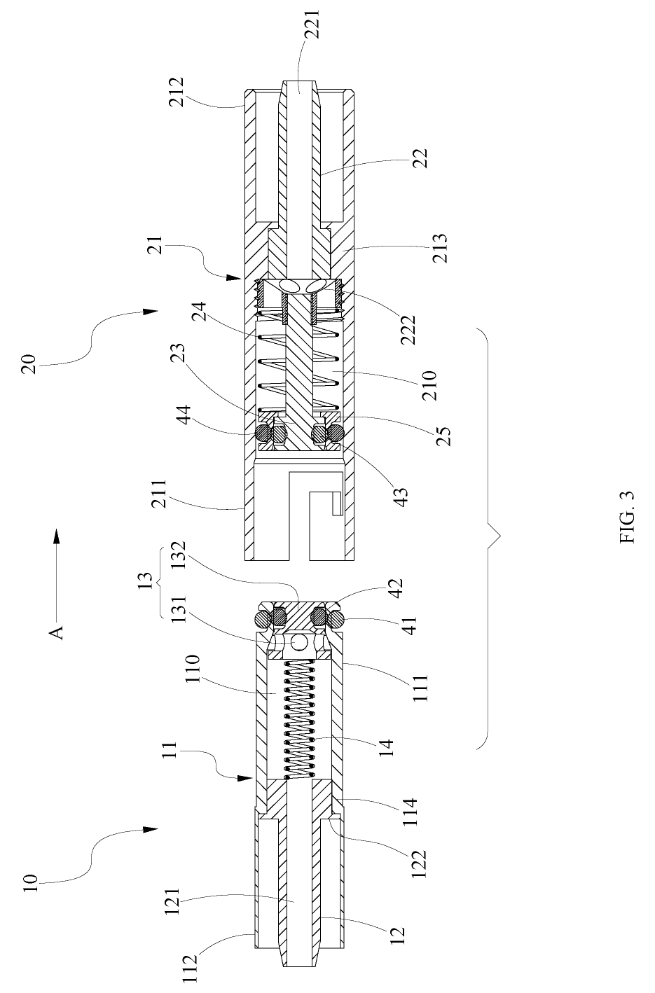

In the present embodiment, the first blocking member (13) comprises a cylindrical blocking portion (132), an outer annular groove (133), an annular sidewall extending axially from a side of the blocking portion (132) opposite to the first engagement port (111), and a plurality of first ports (131) spaced apart in the annular sidewall. The outer annular groove (133) is recessed into an outer peripheral wall of the blocking portion (132) and is configured to accommodate a sealing ring (42). The diameter of the blocking portion (132) substantially corresponds to the inner diameter of the reduced-diameter section. Accordingly, when the blocking portion (132) is positioned in the reduced-diameter section (as shown in FIG. 3), the first engagement port (111) is closed. Conversely, when the blocking portion (132) is displaced within the first flow passage (110) along the axial direction A away from the reduced-diameter section, the first flow passage (110) is placed in fluid communication with the exterior through the first engagement port (111).

The first elastic member (14) is disposed on the first abut member (12) and is positioned between the first blocking member (13) and the first abut member (12). In the present embodiment, the first elastic member (14) is configured as a coil spring capable of extending and contracting along the axial direction A.

In alternative embodiments, the first blocking member (13) may be provided with only a single first port (131). It should be understood that the first blocking member (13) may assume various structural configurations according to functional requirements, provided that at least one first port (131) is formed to allow communication with the first flow passage (110) while simultaneously closing the first engagement port (111). Accordingly, the present invention is not restricted to the foregoing illustrative example or the accompanying drawings.

Referring now to FIGS. 1, 2B, and 3, the second connector unit (20) comprises a second connector body (21), a second abut member (22), a second elastic member (24), a second blocking member (23), and an annular thrust member (25). In this embodiment, a first outer diameter of the first connector body (11) is smaller than a second outer diameter of the second connector body (21), thereby enabling the first connector body (11), with the first engagement port (111) leading, to be inserted axially into the second connector body (21) through the second engagement port (211).

The second connector body (21) is a hollow tubular body defining a second flow passage (210) extending axially therethrough. The second connector body (21) has the second engagement port (211) and a second pipe connecting port (212) disposed at opposite axial ends thereof.

In the present embodiment, the second connector body (21) further comprises a protrusion (213) formed on an inner tube wall and extending inwardly into the second flow passage (210). The protrusion (213) is located between the second elastic member (24) and the second pipe connecting port (212).

The second abut member (22) is fixedly disposed in the second flow passage (210) at a position spaced apart from the second engagement port (211) along the axial direction A.

In this embodiment, the second abut member (22) is tubular, extends along the axial direction A, and defines a second sub-flow passage (221). The second abut member (22) further comprises a second abutting portion (222) abutting the protrusion (213), and a plurality of second ports (223) formed in the second abutting portion (222). The second ports (223) place the second flow passage (210) in fluid communication with the second sub-flow passage (221). The second abutting portion (222) is of a hollow annular configuration, and the second ports (223) are annularly spaced around the second abutting portion (222).

In some embodiments, the second abut member (22) may alternatively be provided with only a single second port (223) communicating the second flow passage (210) with the second sub-flow passage (221). It should be understood that the second abut member (22) may assume different structural configurations depending on functional requirements, provided that the second abut member (22) is capable of abutting against and being secured to the protrusion (213), while defining at least one second port (223) that fluidly communicates the second sub-flow passage (221) with the second flow passage (210). Thus, the second abut member (22) is not limited to the foregoing examples or to the illustrated embodiments.

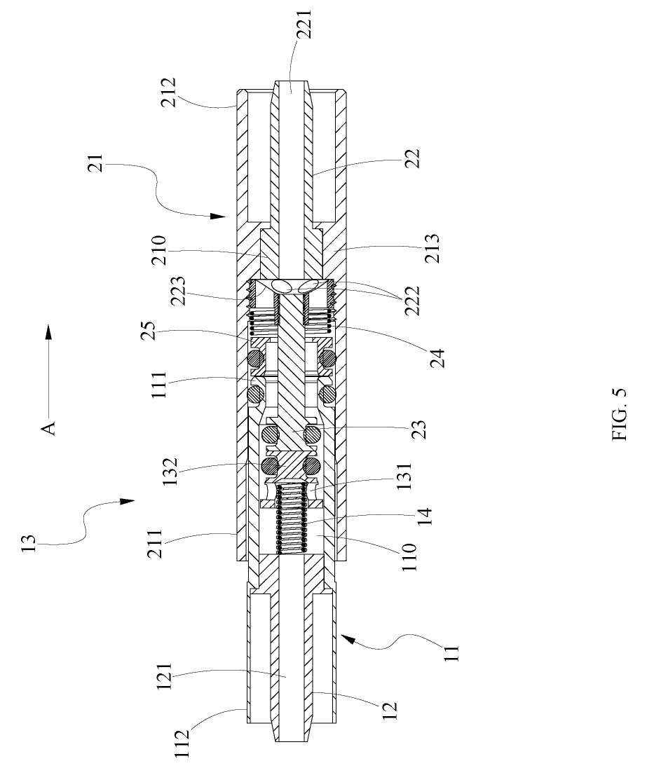

It is worth noting, with reference to FIG. 5, that the second ports (223), which fluidly communicate the second sub-flow passage (221) with the second flow passage (210), can significantly reduce the overall thickness of the second connector unit (20). This is because the present invention simultaneously provides the second abutting portion (222) and the second ports (223), enabling a fluid to flow directly from the second flow passage (210) toward the second abut member (22) and be introduced through the second ports (223) into the second sub-flow passage (221) located on its inner side. Thus, there is no need to reserve an additional annular flow passage space around the periphery of the second abut member (22) to allow the fluid to flow into the second sub-flow passage (221). In other words, the guiding path of the fluid is integrated within the tubular structure of the second abut member (22), allowing the elimination of the need for the additional annular flow passage used in conventional designs. That is to say, the provision of the second ports (223) achieves structural integration and path concentration for the flow of the fluid between the second flow passage (210) and the second sub-flow passage (221). This allows the fluid path of the second connector unit (20) to be completed over the shortest distance, thereby effectively reducing the thickness required for the second connector unit (20) in the radial direction and achieving the effect of overall structural slimming and concentration.

Furthermore, although the second ports (223) are disposed on the annular structure of the second abutting portion (222), the opening size, annular spacing, and total flow cross-sectional area of the second ports (223) can be designed according to flow requirements. This ensures that the effective flow area introduced into the second sub-flow passage (221) is maintained at a predetermined specification. Therefore, the structurally integrated flow guiding configuration adopted by the present invention does not reduce the cross-sectional area through which the fluid can pass, nor does it cause issues such as a decrease in the fluid flow rate or an increase in pressure loss, thereby ensuring that the fluid flow rate is unaffected.

The second blocking member (23) is connected to the second abut member (22) on a side facing the second engagement port (211). In the present embodiment, the second blocking member (23) is of cylindrical form and comprises an outer annular groove (231) recessed into its outer peripheral wall for accommodating a sealing ring (43).

The annular thrust member (25) is axially movably and annularly disposed around the second abut member (22) and the second blocking member (23). In this embodiment, the annular thrust member (25) is a hollow annular body having an inner annular diameter, an outer annular diameter, and an outer annular groove (251) recessed into its outer peripheral wall for receiving a sealing ring (44). The outer annular diameter of the annular thrust member (25) substantially corresponds to the inner diameter of the second flow passage (210), while the inner annular diameter substantially corresponds to the diameter of the second blocking member (23).

When the first connector unit (10) is not engaged with the second connector unit (20), the annular thrust member (25) is positioned adjacent to the second engagement port (211) and annularly surrounds the second blocking member (23). In this position, the annular thrust member (25) cooperates with the second blocking member (23) to close the second flow passage (210), thereby preventing external communication through the second engagement port (211). When the annular thrust member (25) is displaced within the second flow passage (210) along the axial direction A away from the second engagement port (211), the annular thrust member (25) separates from the second blocking member (23), thereby permitting external communication through the second engagement port (211).

The second elastic member (24) is annularly disposed around the second abut member (22) and positioned between the second abutting portion (222) and the annular thrust member (25). In this embodiment, the second elastic member (24) is a coil spring capable of extension and contraction along the axial direction A.

The latching unit (30) comprises at least one latch member (31), which is pressably formed on the first connector body (11), and at least one latching groove (32) formed on the second connector body (21). In the present embodiment, the latching groove (32) extends from the second engagement port (211) in a direction away from the second engagement port (211). The latching groove (32) receives the latch member (31) when the first connector body (11) is inserted into the second connector body (21) through the second engagement port (211), thereby securing the first connector body (11) and the second connector body (21) in a latched state. The latching groove (32) comprises a plurality of extending sections (321) connected end-to-end. Each extending section (321) extends in a direction different from that of the adjoining extending section (321), thereby enabling the latch member (31) to be retained at an end of the latching groove (32) remote from the second engagement port (211). This configuration prevents unintentional disengagement of the first connector body (11) and the second connector body (21) during use. Preferably, the extending section (321) immediately adjacent to the second engagement port (211) extends along the axial direction A.

In the embodiment shown, the latching unit (30) comprises two latch members (31) positioned on opposite sides of the first connector body (11), and two corresponding latching grooves (32) formed on opposite sides of the second connector body (21). This arrangement facilitates user operation, as the two latch members (31) can be simultaneously pressed with balanced force, thereby simplifying coupling and decoupling of the first connector unit (10) and the second connector unit (20).

In operation, force is applied to the two latch members (31), and the first connector body (11), with the first engagement port (111) leading, is inserted into the second connector body (21) through the second engagement port (211) and into the second flow passage (210).

During coupling, the first connector body (11) advances along the axial direction A, while the pressed latch members (31) move along the extending directions of their corresponding latching grooves (32). In this process, the first engagement port (111) pushes the annular thrust member (25) along the axial direction A into abutment with the second elastic member (24). The second elastic member (24) is thereby subjected to axial compression. When the annular thrust member (25) is displaced away from the second blocking member (23), the second flow passage (210) is opened and fluidly communicates externally through a hollow region of the annular thrust member (25) and the second engagement port (211). Simultaneously, the second blocking member (23) contacts the first blocking member (13), pushing the first blocking member (13) along the axial direction A into abutment with the first elastic member (14). When the first blocking member (13) is displaced away from the reduced-diameter section, the first flow passage (110) is opened and fluidly communicates externally through the first engagement port (111).

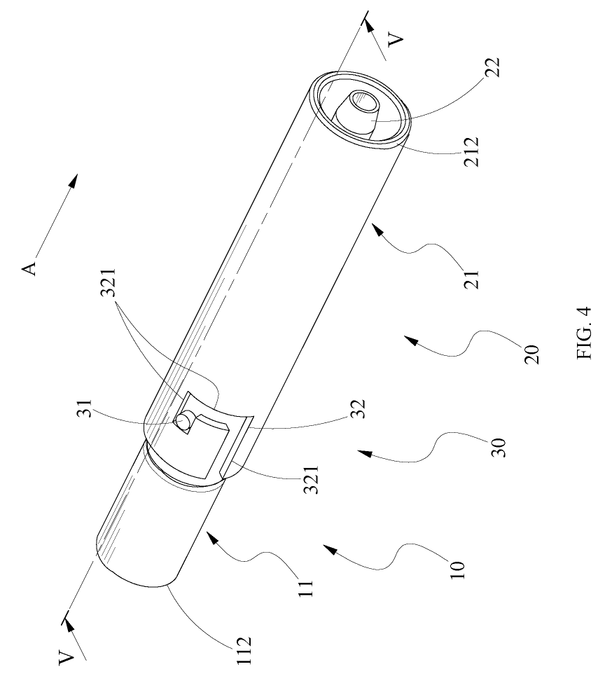

Referring to FIGS. 4 and 5, when the latch members (31) reach the ends of their respective latching grooves (32) opposite to the second engagement port (211), the applied force on the latch members (31) is released, allowing the latch members (31) to snap into the corresponding latching grooves (32). At this point, the first connector unit (10) and the second connector unit (20) are secured in an engaged state, as illustrated in FIGS. 4 and 5.

In the engaged state, the first blocking member (13) is urged by the second blocking member (23) to axially compress the first elastic member (14). As a result, the first elastic member (14) continuously applies a restoring force in the opposite direction to the first blocking member (13) along the axial direction A, thereby maintaining mutual abutment between the first blocking member (13) and the second blocking member (23). This configuration ensures continuous fluid communication among the first flow passage (110), the first ports (131), the first sub-flow passage (121), and the second flow passage (210).

In a disengaged state, the first blocking member (13) is pushed back to the first engagement port (111) by an elastic force of the first elastic member (14). Furthermore, during the switch from the engaged state to the disengaged state , the pressure of the fluid may also facilitate the quick return of the first blocking member (13), enabling the first engagement port (111) to be closed in a timely manner.

Concurrently, in the engaged state, the annular thrust member (25) is urged by the first engagement port (111) to axially compress the second elastic member (24). Consequently, the second elastic member (24) continuously applies a restoring force in the opposite direction to the annular thrust member (25) along the axial direction A, thereby maintaining mutual abutment between the annular thrust member (25) and the first engagement port (111). This configuration maintains the annular thrust member (25) separated from the second blocking member (23), thereby ensuring continuous fluid communication among the second flow passage (210), the second ports (223), the second sub-flow passage (221), and the first flow passage (110).

In the disengaged state, the second blocking member (23) is pushed back to the second engagement port (211) by the elastic force of the second elastic member (24). Furthermore, during the switch from the engaged state to the disengaged state , the pressure of the fluid may also facilitate the quick return of the second blocking member (23), enabling the second engagement port (211) to be closed in a timely manner.

By employing the structural configuration in which the first elastic member (14) is disposed in the first connector unit (10) and the second elastic member (24) is disposed in the second connector unit (20), the quick disconnector ensures that, in the engaged state, the first elastic member (14) and the second elastic member (24) independently provide restoring forces to the first blocking member (13) and the annular thrust member (25), respectively. This structural arrangement guarantees stable communication between the first flow passage (110) and the second flow passage (210), even if one of the elastic members experiences fatigue. Moreover, the structural design of the latching unit (30) not only facilitates user operation for coupling and decoupling of the first connector body (11) and the second connector body (21), but also further prevents inadvertent disengagement of the connector bodies during use.

In summary, when the quick disconnector is in the engaged state, the first elastic member (14) continuously exerts a restoring force to maintain abutment between the first blocking member (13) and the second blocking member (23), while the second elastic member (24) continuously exerts a restoring force to maintain abutment between the annular thrust member (25) and the first engagement port (111). The cooperative design of the first elastic member (14) and the second elastic member (24) reduces the risk of impaired fluid communication between the first flow passage (110) and the second flow passage (210) caused by fatigue of a single elastic member. In addition, the latching unit (30) enhances both ease of operation and structural security, thereby fulfilling the objectives of the present invention.

What is claimed is:

1. A quick disconnector, comprising:
a first connector unit including a first blocking member axially movably disposed within a first flow passage and positioned adjacent to a first engagement port; and
a second connector unit including a second blocking member and an annular thrust member, the second blocking member being connected to a second abut member, and the annular thrust member being axially movably disposed between the second blocking member and the second abut member;
wherein the first engagement port of the first connector unit is insertable into the second connector unit to push the annular thrust member, and simultaneously the second blocking member of the second connector unit is arranged to contact and push the first blocking member of the first connector unit, thereby opening fluid communication between the first flow passage and a second flow passage.

2. The quick disconnector according to claim 1, wherein the first connector unit further comprises a first elastic member and the second connector unit further comprises a second elastic member;
wherein, when the first connector unit and the second connector unit are in an engaged state, the first blocking member compresses the first elastic member, and the annular thrust member compresses the second elastic member; and
wherein, when the first connector unit and the second connector unit are in a separated state, elastic restoring forces of the first elastic member and the second elastic member respectively return the first blocking member and the annular thrust member to initial positions, thereby automatically closing the first flow passage and the second flow passage.

3. The quick disconnector according to claim 1, further comprising a latching unit, the latching unit including at least one latch member formed on a first connector body, and at least one latching groove formed on a second connector body, the latch member being receivable in the latching groove to secure the first connector unit and the second connector unit in the engaged state.

4. The quick disconnector according to claim 1, wherein the first blocking member comprises at least one first port, and wherein when the first blocking member is displaced by the second blocking member, the first port communicates with the first flow passage.

5. The quick disconnector according to claim 2, wherein, when the second blocking member and the annular thrust member are displaced apart from one another, a hollow region is formed therebetween, enabling fluid communication through the second flow passage.
